(19) United States
(12) Patent Application Publication
(10) Pub. No.: US 2015/0031334 A1
(43) Pub. Date: Jan. 29, 2015

(54) Method of Handling Authentication for Wireless Charging

(71) Applicant: HTC Corporation, Taoyuan County (TW)

(72) Inventor: Chih-Hsiang Wu, Taoyuan County (TW)

(21) Appl. No.: 14/340,579

(22) Filed: Jul. 25, 2014

Related U.S. Application Data
(60) Provisional application No. 61/858,586, filed on Jul. 25, 2013.

(51) Int. Cl. H04W 12/06

(52) U.S. Cl. CPC H04W 12/06
USPC 455/411

(57) ABSTRACT

A method of handling authentication for wireless charging which is utilized in a network node comprises transmitting an authentication request to a portable device, after confirming that the portable device connects to a wireless charger; receiving an authentication response for responding the authentication request from the portable device; performing an authentication for the portable device based on the authentication response; and transmitting a message related to a result of the authentication indicating the authentication is successful or not to the wireless charger, after the authentication for the portable device is completed.

### CROSS REFERENCE TO RELATED APPLICATIONS

This application claims the benefit of U.S. Provisional Application No. 61/858,586, filed on Jul. 25, 2013 and incorporated herein by reference.

### BACKGROUND OF THE INVENTION

1. Field of the Invention

The present invention relates to a method used in a wireless communication system, and more particularly, to a method of handling authentication for wireless charging in a wireless communication system.

2. Description of the Prior Art

A mobile device such as a mobile phone and a tablet computer can provide various functions (e.g., via applications installed in the mobile device) such as taking/viewing pictures, playing music and movies, playing games, sending/receiving emails and messages, etc., to the user. Size and power consumption of the mobile device have been continuously and significantly reduced due to development of semiconductor technologies. Thus, the mobile device has become a daily and essential appliance carried by a user.

Even though design of the mobile device is greatly improved nowadays, the mobile device needs to be charged via a power line. That is, a cable is needed for connecting between the mobile device and a power socket, such that the mobile device can be charged. Inconvenience is caused to a user of the mobile device. Thus, wireless charging is currently discussed and developed to overcome the inconvenience caused by the traditional charging, i.e., wireline charging. The mobile device can be charged without using the cable by simply touching a wireless charger (e.g., a power plate) or by being closed to the wireless charger, when the wireless charging is used. However, the wireless charging cannot be easily managed due to its convenience. For example, an owner of the wireless charger (e.g., operator) may not desire to provide the wireless charging to unauthorized users, e.g., the user without signing a contract with the owner. The owner of wireless charger may pay a greater cost on electricity and more hardware cost due to wireless charging being used by the unauthorized users.

Thus, management of the wireless charging is an important problem to be solved.

### SUMMARY OF THE INVENTION

The present invention therefore provides a method and related portable device for handling authentication for wireless charging to solve the abovementioned problem.

A method of handling authentication for wireless charging which is utilized in a network node comprises transmitting an authentication request to a portable device, after confirming that the portable device connects to a wireless charger; receiving an authentication response for responding the authentication request from the portable device; performing an authentication for the portable device based on the authentication response; and transmitting a message related to a result of the authentication indicating the authentication is successful or not to the wireless charger, after the authentication for the portable device is completed.

A method of handling authentication for wireless charging which is utilized in a portable device comprises receiving an authentication request from a network node, after the portable device connects to a wireless charger; transmitting an authentication response for responding the authentication request to the network node; receiving a message related to a result of an authentication for the portable device, wherein the authentication for the portable device is performed by the network node; and displaying a notification in response to the message when the message indicates the authentication is unsuccessful, to notify that the portable device is not allowed to be charged via the wireless charger.

A method of handling authentication for wireless charging which is utilized in a wireless charger comprises transmitting a first message to a network node to notify that a portable device connects to the wireless charger, after detecting that the portable device connects to the wireless charger; receiving a second message related to a result of an authentication for the portable device from the network node, wherein the authentication for the portable device is performed by the network node; and determining whether to wirelessly charge the portable device based on the second message.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless charging system according to an example of the present invention.

FIG. 2 is a schematic diagram of a device according to an example of the present invention.

FIG. 3 is a schematic diagram of a wireless charger and a portable device according to an example of the present invention.

FIG. 4 is a flowchart of a process according to an example of the present invention.

FIG. 5A and FIG. 5B are flowcharts of processes operated in a wireless charging system according to an example of the present invention.

FIG. 6 is a flowchart of a process according to an example of the present invention.

FIG. 7 is a flowchart of a process according to an example of the present invention.

### DETAILED DESCRIPTION

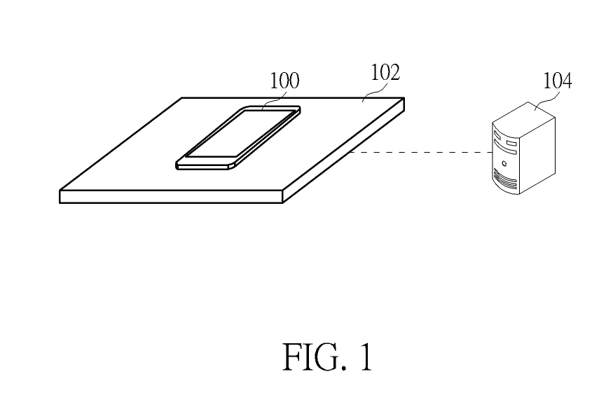

FIG. 1 is a schematic diagram of a wireless charging system 10 according to an example of the present invention. The wireless communication system 10 is briefly composed of a portable device 100, a wireless charger 102 and a network node 104, to illustrate the structure of the wireless charging system 10. The wireless charger 102 may charge a battery of the portable device 100, when the portable device 100 attaches to or gets close to the wireless charger 102 in a predetermined distance. The network node 104 may manage (e.g., control) the wireless charger 102, and authenticate the portable device 100 to determine whether the portable device 100 is allowed to use the wireless charging function provided by the wireless charger 102.

Practically, the network node 104 may be a Node B, a Radio Network Controller (RNC), an evolved Node B (eNB), or a relay station in an evolved UTRAN (E-UTRAN), a long term evolution (LTE) system, a LTE-Advanced (LTE-A) system or an evolution of the LTE-A system. In another example, the network node 104 may be a Mobility Management Entity (MME), Serving Gateway (S-GW), Packet Data Network (PDN) Gateway (P-GW), Self-Organizing Networks (SON) server, or a server capable of managing (e.g., controlling) the wireless charging function, and may be administrated by an operator, a specific owner, etc.

The portable device 100 may be a user equipment (UE), for example a machine type communication (MTC) device, a mobile phone, a laptop, a tablet, an electronic book or a portable computer system. In addition, the wireless charger 102/the network node 104 and the portable device can be seen as a transmitter or a receiver according to direction of messages or signalings. For example, for an uplink (UL), the portable device 100 is the transmitter, and the wireless charger 102/the network node 104 is the receiver. For a downlink (DL), the wireless charger 102 or the network node 104 is the transmitter, and the portable device 100 is the receiver.

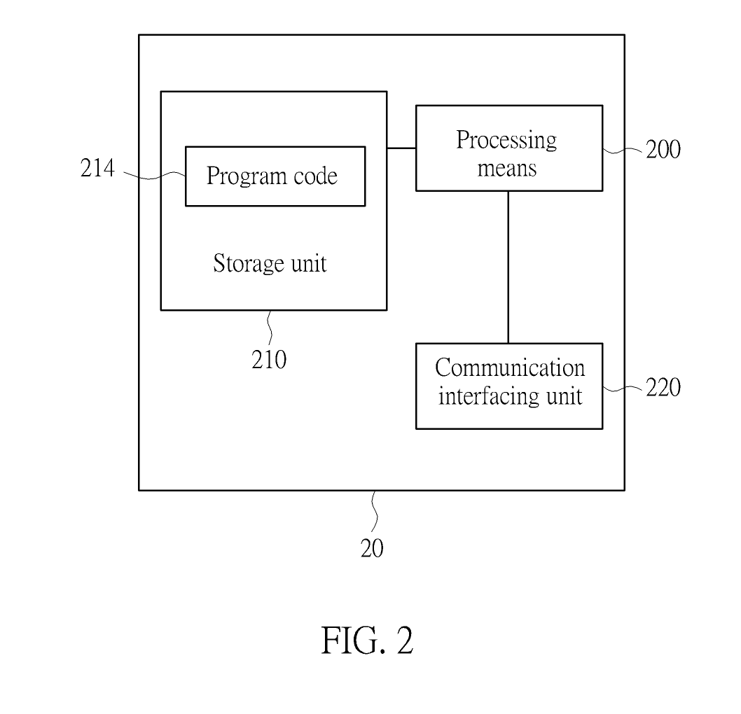

FIG. 2 is a schematic diagram of a device 20 according to an example of the present invention. The device 20 may be the network node 104 shown in FIG. 1. The device 20 may include a processing means 200 such as a microprocessor or Application Specific Integrated Circuit (ASIC), a storage unit 210 and a communication interfacing unit 220. The storage unit 210 may be any data storage device that may store a program code 214, accessed and executed by the processing means 200. Examples of the storage unit 210 include but are not limited to a subscriber identity module (SIM), read-only memory (ROM), flash memory, random-access memory (RAM), CD-ROM/DVD-ROM, magnetic tape, hard disk and optical data storage device. The communication interfacing unit 220 is preferably a transceiver and is used to transmit and receive signals (e.g., data, signals, messages and/or packets) according to processing results of the processing means 200.

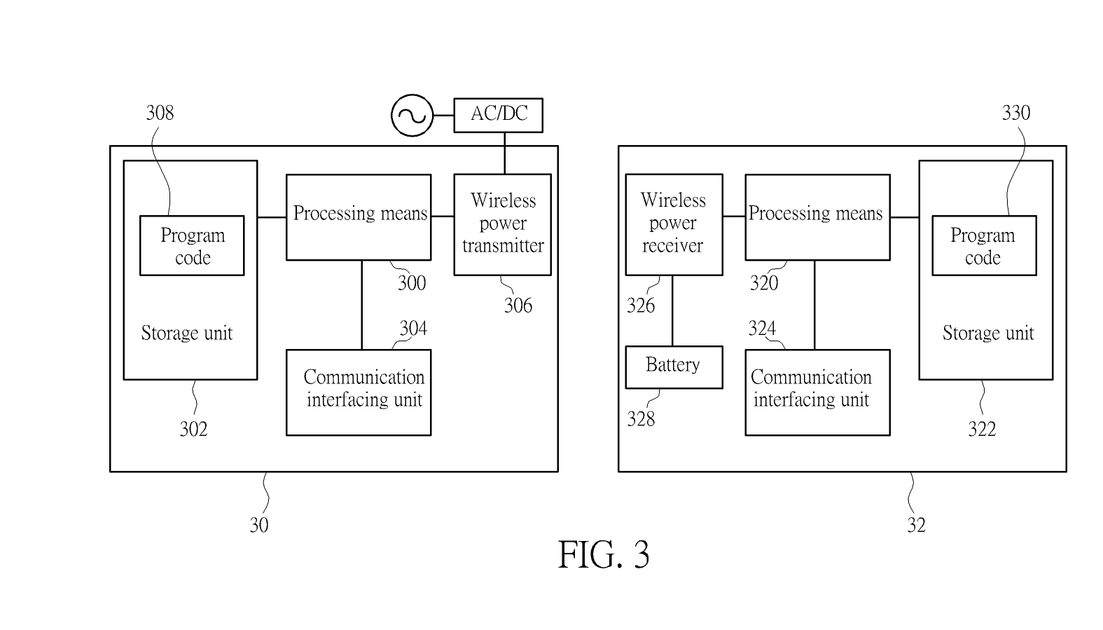

FIG. 3 is a schematic diagram of a wireless charger 30 and a portable device 32 according to an example of the present invention. The wireless charger 30 maybe the wireless charger 102 shown in FIG. 1, and the portable device 32 may be the portable device 100 shown in FIG. 1. The wireless charger 30 and the portable device 32 can use a wireless charging standard developed by any wireless charging standard group, such as Wireless Power Consortium (WPC), Alliance For Wireless Power (A4WP), Power Matter Alliance (PMA), but is not limited herein. The wireless charger 30 may include a processing means 300, a storage unit 302, a communication interfacing unit 304 and a wireless power transmitter 306. The storage unit 302 may be any data storage device that may store a program code 308, accessed and executed by the processing means 300. The communication interfacing unit 304 is preferably a transceiver and is used to transmit and receive signals (e.g., data, signals, messages and/or packets) according to processing results of the processing means 300. The wireless power transmitter 306 can receive DC power and perform power transfer to the portable device 32.

The portable device 32 may include a processing means 320, a storage unit 322, a communication interfacing unit 324, a wireless power receiver 326 and a battery 328. The storage unit 242 may be any data storage device that may store a program code 330, accessed and executed by the processing means 320. The communication interfacing unit 324 is preferably a transceiver and is used to transmit and receive signals (e.g., data, signals, messages and/or packets) according to processing results of the processing means 320. The wireless power receiver 326 can receive power from the wireless power transmitter 306 of the wireless charger 30, to charge the battery 328.

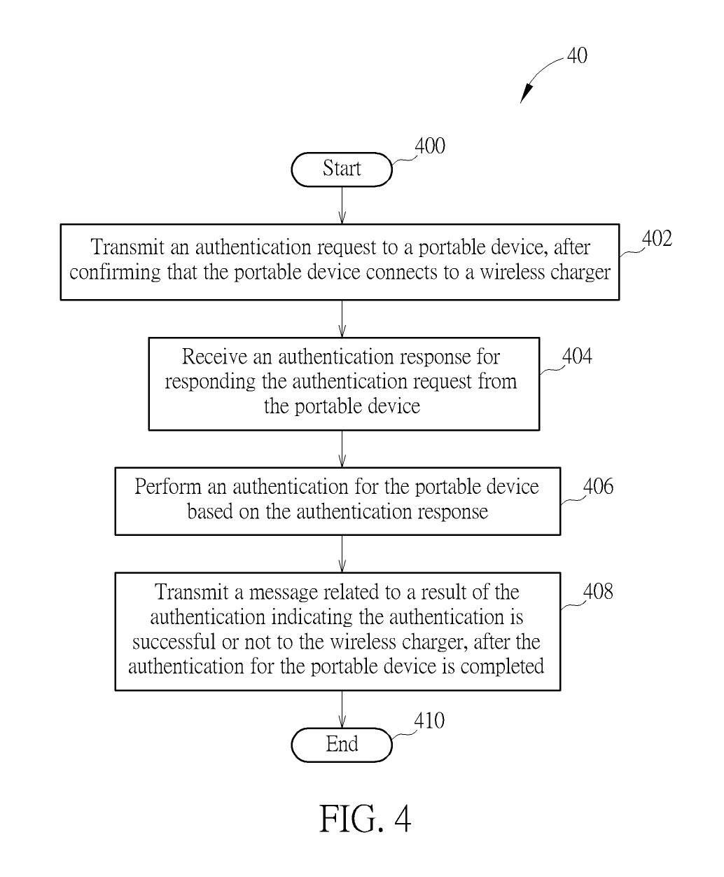

FIG. 4 is a flowchart of a process 40 according to an example of the present invention. The process 40 may be utilized in the network node 104 (e.g., the device 20 of FIG. 2), for handling authentication for wireless charging. The process 40 may be compiled into the program code 214 and includes the following steps:

Step 400: Start.

Step 402: Transmit an authentication request to a portable device, after confirming that the portable device connects to a wireless charger.

Step 404: Receive an authentication response for responding the authentication request from the portable device.

Step 406: Perform an authentication for the portable device based on the authentication response.

Step 408: Transmit a message related to a result of the authentication indicating the authentication is successful or not to the wireless charger, after the authentication for the portable device is completed.

Step 410: End.

According to the process 40, the network node 104 transmits an authentication request to the portable device 100 (e.g., the device 32 of FIG. 3), after confirming that the portable device 100 connects to the wireless charger 102 (e.g., the device 30 of FIG. 3). The network node 104 receives an authentication response for responding the authentication request from the portable device 100, and performs an authentication for the portable device 100 based on the authentication responses. Then, the network node 104 transmits a message related to a result of the authentication to the wireless charger, after the authentication for the portable device is completed. Because the authentication for the portable device 100 may be successful or unsuccessful, the result of the authentication can indicate that the authentication is successful or not (i.e., unsuccessful or fails). Therefore, the message sent to the wireless charger 102 may have different meanings or may include different information.

The wireless charger 102 determines whether to charge the portable device 100 in response to the message sent from the network node 104. In other words, whether the portable device 100 should be charged by the wireless charger 102 is determined by the network node 104, when the portable device 100 intends to be wirelessly charged via the wireless charger 102. The wireless charger 102 charges the portable device 100, if the network node 104 authenticates the portable device 100 successfully. Thus, the wireless charging can be managed according to the above description. The problem that a wireless charger may charge portable devices owned by unauthorized users is solved.

Realization of the present invention is not limited to the above description.

For example, the message in the process 40 may indicates a success of the authentication, when the authentication is successful. In another example, the message may include a charging command instructing the wireless charger 102 to charge the portable device 100, when the authentication is successful. In another example, the message may indicate a failure of the authentication, when the authentication is unsuccessful. In another example, the message may include information indicating not to charge the portable device 100, when the authentication is unsuccessful. In another example, the message may trigger a notification to be displayed in the portable device 100, to notify that the portable device 100 is not allowed to be charged, when the authentication is unsuccessful.

The network node 104 may receive timing information transmitted by the wireless charger 102, wherein the timing information is related to when the wireless charger 102 finishes charging the portable device 100. For example, the timing information may include a time interval during which the portable device 100 is charged, e.g., 50 minutes. In another example, the timing information may include a start, an end of the time interval and/or a total length of the time interval, and the network node 104 may obtain (e.g., calculate) the time interval according to the start and the end. Then, the network node 104 may obtain billing information according to the time interval. In another example, the timing information may include the total length of the time interval. In another example, the network node 104 may receive billing information transmitted by the wireless charger 102, wherein the billing information may be generated according to a time interval during which the wireless charger 102 charges the portable device 100. That is, the network node 104 does not need to calculate the billing information which is calculated by the wireless charger 102 instead.

Methods according to which the authentication request and the authentication response in the process 30 are processed are not limited herein. For example, the network node 104 may transmit the authentication request to the portable device 100 directly, or via the wireless charger 102. Similarly, the network node 104 may receive the authentication response transmitted by the portable device 100 directly, or via the wireless charger 102. A protocol according to which the authentication request and the authentication response are transmitted between the portable device 100 and the wireless charger 102 is not limited. For example, the authentication request and/or the authentication response may be transmitted according to a near field communication (NFC), WiFi or Bluetooth.

The authentication request may include challenge information, and the authentication response may include challenge response generated according to the challenge information. That is, the challenge information and the challenge response are used for authenticating the portable device 100. In one example, the challenge response may be generated by the portable device 100 according to one or more security algorithms, one or more security keys or according to an identification of the portable device. For example, the identification may be a subscriber identification module (SIM), universal subscriber identity module (USIM), etc. The one or more security keys may be stored in the SIM, the USIM or a flash memory of the portable device 100. In addition, the challenge information may include a random challenge (RAND) and an authentication token (AUTN), and the challenge response is generated according to the random challenge and the authentication token. On the other hand, the wireless charger 102 charges the portable device 100 according to Wireless Power Consortium (WPC), Power Matters Alliance (PMA) or Alliance for Wireless Power (A4WP).

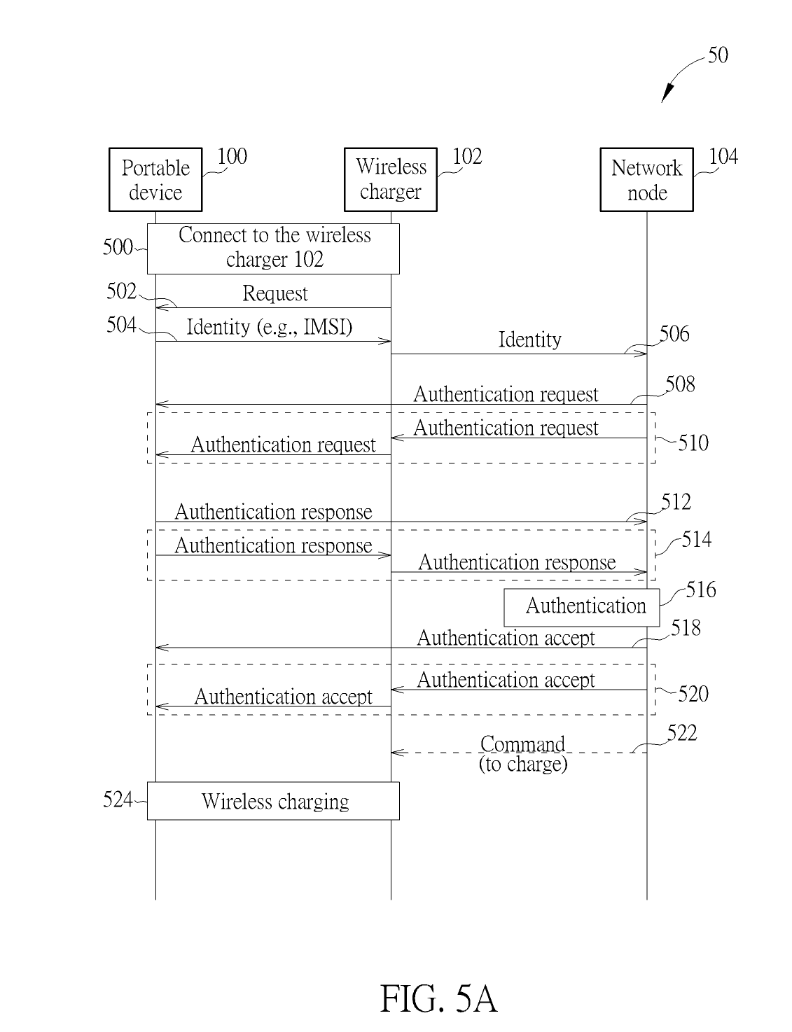

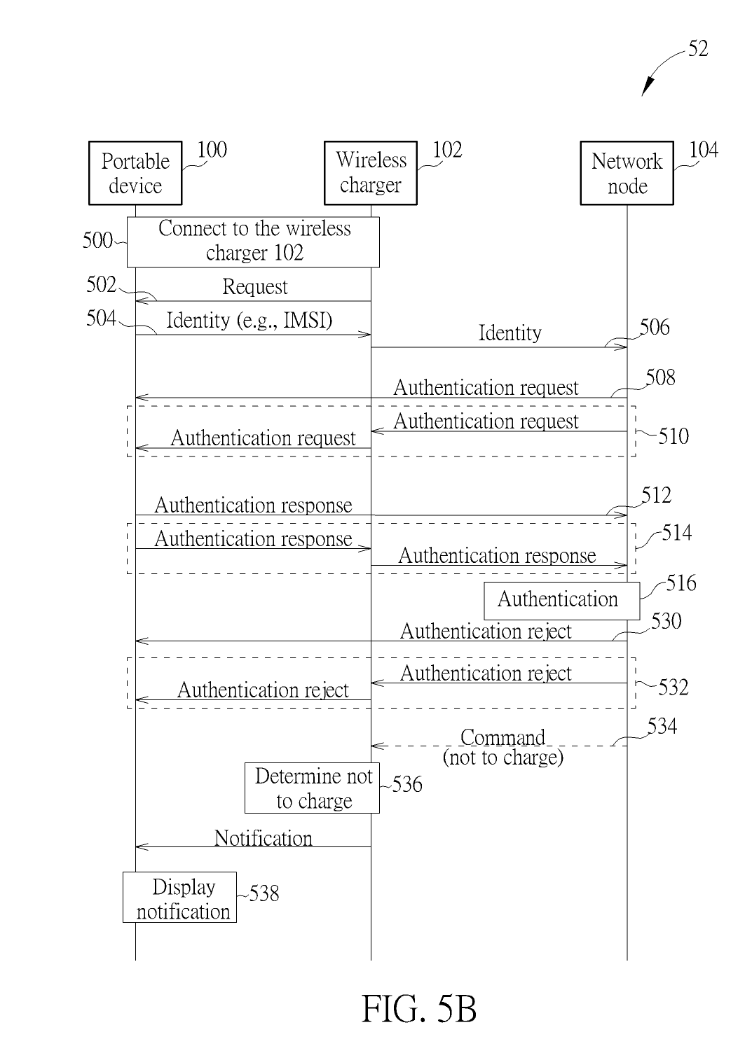

Please refer to message flows shown in FIG. 5A and FIG. 5B for understanding the process 40. FIG. 5A and FIG. 5B are flowcharts of process 50 and 52 operated in a wireless charging system according to an example of the present invention, wherein the wireless charging system includes the portable device 100, the wireless charger 102 and the network node 104 as shown in FIG. 1. Note that the message flows in FIG. 5A illustrate the situation where the authentication for the portable device 100 is successful, and the message flows in FIG. 5B illustrate the situation where the authentication for the portable device 100 is unsuccessful (i.e., authentication fails).

As shown in the process 50, at the beginning, the portable device 100 may initialize a communication with the wireless charger (step 500), e.g., by detecting inductance change, touching and/or approaching the wireless charger 102, to request wireless charging. Alternatively the wireless charger 102 may initialize a communication with the portable device when the wireless charger detects the portable device 100 by detecting inductance change, the portable device 100′s touching and/or the portable device 100's approaching the wireless charger 102. The wireless charger 102 may transmit a request to the portable device 100, to request an identity of the portable device 100 (step 502). The portable device 100 may transmit its identity (e.g., international mobile subscriber identity (IMSI)) to the wireless charger 102 to reply the request (step 504). The wireless charger 102 may forward the identity to the network node 104, to request authentication for the wireless charging (step 406), after receiving the identity. Then, the network node 104 starts to authenticate the portable device 100 by transmitting an authentication request to the portable device 100. As stated previously, the network node 104 may transmit the authentication request to the portable device 100 directly (step 508), or the network node 104 may transmit the authentication request to the portable device 100 via the wireless charger 102 (step 510). Then, the portable device 100 may transmit an authentication response to the network node 104 directly (step 512), or the portable device 100 may transmit the authentication response to the network node 104 via the wireless charger 102 (step 514). The contents of the authentication request and the authentication response and the relation between the authentication request and the authentication response can be referred to the previous description, and is not narrated herein.

Then, the network node 104 may perform the authentication according to the authentication response (step 516). The network node 104 may transmit an authentication accept message to the wireless charger 102, to indicate to the wireless charger 102 to charge the portable device 100, if the authentication response is authenticated successfully. Furthermore, the network node 104 may transmit the authentication accept message to the portable device 100 directly (step 518), or the network node 104 may transmit the authentication accept message to the portable device 100 via the wireless charger 102 (step 520). In addition to the authentication accept message, the network node 104 may also transmit a command to the wireless charger 102, to instruct the wireless charger 102 to charge the portable device 100 (step 522). Thus, the portable device 100 may start to perform the wireless charging via the wireless charger 102 (step 524). Note that the authentication accept message and the command instructing to charge are simply examples of the message sent from the network node 104 in the process 40. When the message is sent from the network node 104 to the wireless charger 102 (without further transmitting to the portable device 100), the message can be a combination of the authentication accept message and the command instructing to charge, or any one of them.

In another example, the authentication response may not be authenticated successfully, as shown in the process 52 of FIG. 5B. Steps 500-516 in FIG. 5B are similar to those in FIG. 5A, and are not narrated herein. The network node 104 may transmit an authentication reject message to the wireless charger 102, if the authentication response is authenticated unsuccessfully. Furthermore, the network node 104 may transmit the authentication reject message to the portable device 100 directly (step 530), or the network node 104 may transmit the authentication reject message to the portable device 100 via the wireless charger 102 (step 532). In addition to the authentication reject message, the network node 104 may transmit another command to the wireless charger 102 to indicate to the wireless charger 102 not to charge the portable device 100, if the authentication response is not authenticated successfully (step 534). Accordingly, the wireless charger 102 determines not to charge the portable device 100 according to the command (step 536). In addition, if the portable device 100 receives the authentication reject message (step 530) directly or indirectly from the network node 104, the portable device 100 may display a notification to notify that the portable device 100 is not allowed to be charged (step 538). Alternatively, the wireless charger 102 may trigger a notification to be displayed in the portable device 100, to notify that the portable device 100 is not allowed to be charged (step 538). Note that the authentication reject message and the command instructing not to charge are simply examples of the message sent from the network node 104 in the process 40. When the message is sent from the network node 104 to the wireless charger 102 (without further transmitting to the portable device), the message can be a combination of the authentication reject message and the command instructing not to charge, or any one of them.

It should be noted that the network node 104 may not authenticate the authentication response successfully, because the portable device 100 does not subscribe wireless charging service provided by an operator controlling the network node 104. For another example, the network node 104 may not authenticate the authentication response successfully, because the prepaid money of the portable device 100 subscribing the wireless charging service is lower than a predetermined amount. Furthermore, the network 104 may early detect the portable device 100 does not subscribe the wireless charging service using the identity received in the step 506. The identity may contain information related to the operator. For example, the identity may be IMSI, Medium Access Control (MAC) address or a binary/decimal/hex-decimal value specified by an identity assignment organization.

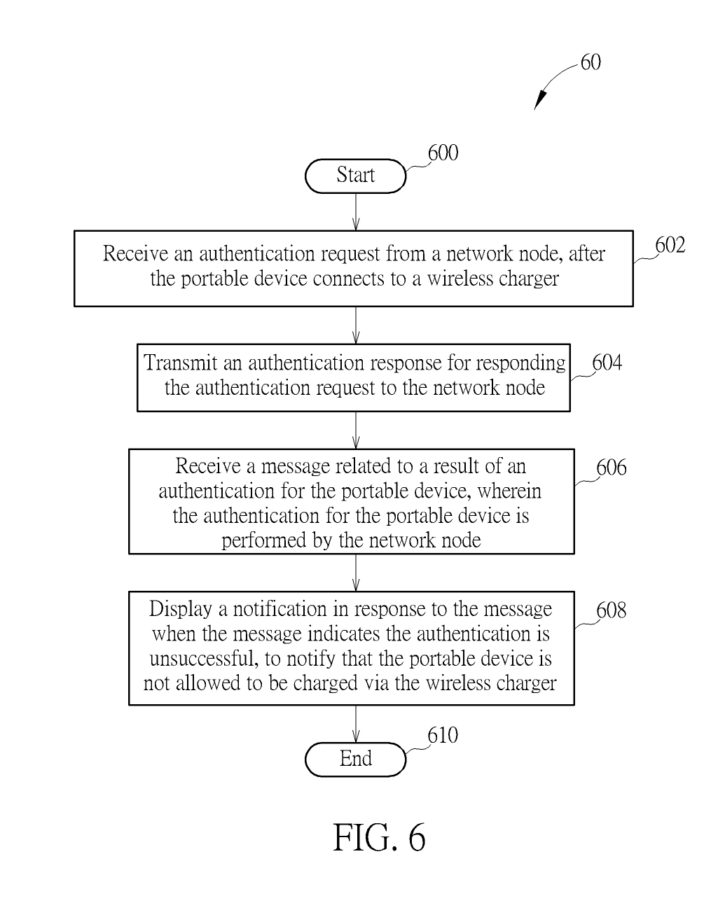

Operations of the portable device 100 in the process 50 and 52 can be summarized into a process 60 as shown in FIG. 6. The process 60 may be utilized in the portable device 100, for handling authentication for wireless charging. The process 60 may be compiled into the program code 330 and includes the following steps:

Step 600: Start.

Step 602: Receive an authentication request from a network node, after the portable device connects to a wireless charger.

Step 604: Transmit an authentication response for responding the authentication request to the network node.

Step 606: Receive a message related to a result of an authentication for the portable device, wherein the authentication for the portable device is performed by the network node.

Step 608: Display a notification in response to the message when the message indicates the authentication is unsuccessful, to notify that the portable device is not allowed to be charged via the wireless charger.

Step 610: End.

Although detailed operations of the process 60 can be referred to the above illustration related to the processes 50 and 52 in FIGS. 5A and 5B, some possible examples for realizing the process 60 are further illustrated as follows.

For example, the message may indicate a success of the authentication when the authentication is successful. The message may be received directly from the network node 104 (e.g., step 518), or may be received via the wireless charger 102 (e.g., step 520). In addition, the message may indicate a failure of the authentication when the authentication is unsuccessful. The message maybe received directly from the network node 104 (e.g., step 530), or may be received via the wireless charger 102 (e.g., step 532). In one example, the portable device 100 may receive the authentication request directly from the network node 104 (e.g., step 508) or via the wireless charger 102 (e.g., step 510). In another example, the portable device 100 may transmit the authentication response directly to the network node 104 (e.g., step 512) or via the wireless charger 102 (e.g., step 514).

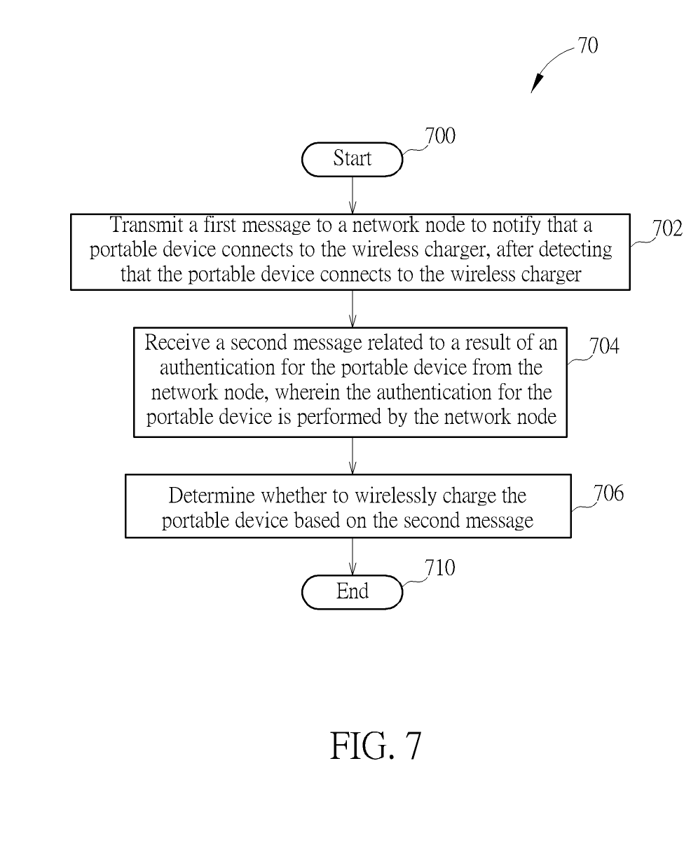

Operations of the wireless charger 102 in the processes 50 and 52 can be summarized into a process 70 as shown in FIG. 7. The process 70 may be utilized in the wireless charger 102, for handling authentication for wireless charging. The process 70 may be compiled into the program code 308 and includes the following steps:

Step 700: Start.

Step 702: Transmit a first message to a network node to notify that a portable device connects to the wireless charger, after detecting that the portable device connects to the wireless charger.

Step 704: Receive a second message related to a result of an authentication for the portable device from the network node, wherein the authentication for the portable device is performed by the network node.

Step 706: Determine whether to wirelessly charge the portable device based on the second message.

Step 708: End.

Although detailed operations of the process 70 can be referred to the above illustration related to the processes 50 and 52, some possible examples for realizing the process 70 are further illustrated as follows.

As mentioned as the above, the portable device 100 may transmit its identity (e.g., IMSI) to the wireless charger 102 to reply the request (e.g., step 504). Note that the first message in Step 702 is a message including the identity of the portable device 100. The wireless charger 102 may forward the message including the identity to the network node 104 (e.g., step 506), to notify that there is the portable device 100 connecting to the wireless charger 102, i.e., to request the network node 104 to perform an authentication for the portable device 100 for wireless charging.

The wireless charger 102 may receive an authentication request from the network node 104 in response to the first message, and may transmit (e.g., forward) the authentication request to the portable device 100 (e.g., step 510). Next, the wireless charger 102 may receive an authentication response for responding the authentication request from the portable device 100, and may transmit (e.g., forward) the authentication response to the network node 104 (e.g., step 514). After the network node 104 completes the authentication for the portable device 100, the wireless charger 102 receives the second message related to the result of the authentication for the portable device 100 from the network node 104 in step 704. The second message may indicate a failure of the authentication or comprises information indicating not to charge the portable device 100, when the authentication is unsuccessful (e.g., step 532).

In step 706 the wireless charger 102 may determine to charge or not to charge the portable device 100 based on the received second message, and may transmit a third message to the portable device 100 after determining not to charge the portable device 100 based on the second message (e.g., step 534), to notify that the portable device 100 is not allowed to be charged.

Those skilled in the art should readily make combinations, modifications and/or alterations on the abovementioned description and examples. The abovementioned steps of the processes including suggested steps can be realized by means that could be a hardware, a firmware known as a combination of a hardware device and computer instructions and data that reside as read-only software on the hardware device, or an electronic system. Examples of hardware can include analog, digital and mixed circuits known as microcircuit, microchip, or silicon chip. Examples of the electronic system can include a system on chip (SOC), system in package (SIP), a computer on module (COM), and the device 20.

To sum up, the present invention provides a method of handling authentication for wireless charging. Thus, the wireless charging can be managed according to the present invention. The problem that a wireless charger may charge portable devices owned by unauthorized users is solved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of handling authentication for wireless charging, the method being utilized in a network node, comprising:
transmitting an authentication request to a portable device, after confirming that the portable device connects to a wireless charger;
receiving an authentication response for responding the authentication request from the portable device;
performing an authentication for the portable device based on the authentication response; and
transmitting a message related to a result of the authentication indicating the authentication is successful or not to the wireless charger, after the authentication for the portable device is completed.

2. The method of claim 1, wherein the message indicates a success of the authentication, when the authentication is successful.

3. The method of claim 1, wherein the message comprises a charging command instructing the wireless charger to charge the portable device, when the authentication is successful.

4. The method of claim 1, wherein the message indicates a failure of the authentication, when the authentication is unsuccessful.

5. The method of claim 1, wherein the message comprises information indicating not to charge the portable device, when the authentication is unsuccessful.

6. The method of claim 1, wherein the message triggers a notification to be displayed in the portable device, to notify that the portable device is not allowed to be charged, when the authentication is unsuccessful.

7. The method of claim 1, further comprising:
receiving timing information transmitted by the wireless charger, wherein the timing information is related to when the wireless charger finishes charging the portable device.

8. The method of claim 1, further comprising:
receiving billing information transmitted by the wireless charger, wherein the billing information is generated according to a time interval during which the wireless charger charges the portable device.

9. The method of claim 1, wherein the network node transmits the authentication request to the portable device via the wireless charger.

10. The method of claim 1, wherein the network node receives the authentication response transmitted by the portable device via the wireless charger.

11. The method of claim 1, wherein the authentication request comprises challenge information, and the authentication response comprises challenge response generated according to the challenge information.

12. The method of claim 11, wherein the challenge information comprises a random challenge and an authentication token, and the challenge response is generated according to the random challenge and the authentication token.

13. A method of handling authentication for wireless charging, the method being utilized in a portable device, comprising:
receiving an authentication request from a network node, after the portable device connects to a wireless charger;
transmitting an authentication response for responding the authentication request to the network node;
receiving a message related to a result of an authentication for the portable device, wherein the authentication for the portable device is performed by the network node; and
displaying a notification in response to the message when the message indicates the authentication is unsuccessful, to notify that the portable device is not allowed to be charged via the wireless charger.

14. The method of claim 13, wherein the message indicates a success of the authentication when the authentication is successful, and the message is received directly from the network node or received via the wireless charger.

15. The method of claim 13, wherein the message indicates a failure of the authentication when the authentication is unsuccessful, and the message is received directly from the network node or received via the wireless charger.

16. The method of claim 13, wherein the portable device receives the authentication request directly from the network node or via the wireless charger.

17. The method of claim 13, wherein the portable device transmits the authentication response directly to the network node or via the wireless charger.

18. A method of handling authentication for wireless charging, the method being utilized in a wireless charger, comprising:
transmitting a first message to a network node to notify that a portable device connects to the wireless charger, after detecting that the portable device connects to the wireless charger;
receiving a second message related to a result of an authentication for the portable device from the network node, wherein the authentication for the portable device is performed by the network node; and
determining whether to wirelessly charge the portable device based on the second message.

19. The method of claim 18, further comprising:
receiving an authentication request from a network node in response to the first message, and transmitting the authentication request to the portable device; and
receiving an authentication response for responding the authentication request from the portable device, and transmitting the authentication response to the network node.

20. The method of claim 18, further comprising:
transmitting a third message to the portable device after determining not to charge the portable device, to notify that the portable device is not allowed to be charged.

21. The method of claim 18, wherein the second message indicates a success of the authentication or comprises a charging command instructing the wireless charger to charge the portable device, when the authentication is successful.

22. The method of claim 18, wherein the second message indicates a failure of the authentication or comprises information indicating not to charge the portable device, when the authentication is unsuccessful.
